(19) United States
(12) Patent Application Publication
(10) Pub. No.: US 2017/0217777 A1
(43) Pub. Date: Aug. 3, 2017

(54) Transfer Method for Two-Dimensional Film

(71) Applicant: Massachusetts Institute of Technology, Cambridge, MA (US)

(72) Inventors: Jin-Yong Hong, Malden, MA (US); Jing Kong, Winchester, MA (US)

(73) Assignee: Massachusetts Institute of Technology, Cambridge, MA (US)

(21) Appl. No.: 15/419,090

(22) Filed: Jan. 30, 2017

Related U.S. Application Data
(60) Provisional application No. 62/289,202, filed on Jan. 30, 2016.

(51) Int. Cl. C01B 31/02; B05D 1/00

(52) U.S. Cl. CPC C01B 31/0484; B05D 1/005; C01B 31/0453; C01B 2204/04

(57) ABSTRACT

A two-dimensional film (such as graphene) is formed on a surface of a growth substrate. A first surface of the two-dimensional film adheres to the growth substrate, and a second surface of the two-dimensional film is then coated with a conforming carrier layer comprising ethylene vinyl acetate. The surface of the growth substrate is etched to release the two-dimensional film with the conforming carrier layer from the growth substrate, wherein the conforming carrier layer maintains the integrity of the two-dimensional film during and after its release from the growth substrate. The first surface of the two-dimensional film with the conforming carrier layer coating is then applied onto a target substrate to form a graphene coating on the target substrate. The conforming carrier layer is then removed from the two-dimensional film by exposing the conforming carrier layer to a solvent while the two-dimensional film is coating the target substrate.

### RELATED APPLICATION

This application claims the benefit of U.S. Provisional Application No. 62/289,202, filed 30 Jan. 2016, the entire content of which is incorporated herein by reference.

### GOVERNMENT SUPPORT

This invention was made with government support under Grant No. 6929129 awarded by the National Science Foundation. The Government has certain rights in the invention.

### BACKGROUND

Since the successful isolation of an atomic layer graphene from its bulk in 2004, a tremendous amount of knowledge and technology development has been generated regarding this material. While chemical-vapor-deposition (CVD) synthesis using metal foils can produce high-quality graphene material on an industrial scale, transfer procedures are generally required to remove the underlying metallic substrates in order to use the graphene. For this purpose, a polymer supporting layer has been used, up to now.

Poly(methyl-methacrylate) (PMMA) has been the predominant choice for the polymer supporting layer until now due to its ease in handling and processing. In particular, U.S. Pat. No. 8,535,553 B2 (Jing Kong, Alfonso Reina Cecco, and Mildred Dresselhaus) discloses using a PMMA transfer/carrier layer to transfer graphene from a growth substrate to a target substrate.

Nevertheless, examples of the graphene transfer process using PMMA have not been completely satisfactory: the transferred graphene very often shows cracks and tears resulting from the transfer; PMMA may not be fully washed away with solvent, and its residues tend to act as scattering centers for charge carriers, thereby degrading the electrical properties of the graphene. Furthermore, it has been very challenging to transfer the graphene onto substrates that have surface features such as terraces or grooves.

Consider, for example, the process of transferring graphene to a substrate with surface features. Researchers have reported that the transferred graphene is often broken around those features. In a typical PMMA-mediated wet-transfer process, a PMMA/graphene film is placed on a target substrate by being scooped in a de-ionized (DI) water bath and then dried by compressed N₂. If there is a pre-patterned structure with a certain aspect ratio on the substrate, then while the graphene region contacted on the horizontal side of the structure is dried, the side wall of the structure retains trapped water, suspending the PMMA/graphene sheet. Tearing of graphene at these side wall regions has been observed, possibly due to the large surface tension during the drying process or due to aggressively blowing N₂ to push the graphene/PMMA to lie conformally on the substrate. This difficulty of the graphene transfer limits the use of graphene in many important applications with uneven features in the topology of the substrate.

In addition, wrinkles have been observed ubiquitously in CVD graphene; and studies have shown that these wrinkles are undesirable for carrier transport. There might be various reasons for the wrinkles to form; one most commonly considered is the fact that graphene has a negative coefficient of thermal expansion (CTE) while the underling metal substrates have a positive value. Moreover, the wet-transfer process carried out in a DI water bath also creates additional wrinkles in the graphene when transferred onto a final target substrate (e.g., an SiO₂/Si wafer). Wrinkles have been shown to cause scattering of carriers (which reduces mobility), and the carbon atoms along the wrinkle are found to be less stable due to curvature effect. Accordingly, wrinkle-free graphene may be advantageous in a variety of applications.

### SUMMARY

Methods, apparatus, and intermediate and resulting products for/from the transfer of two-dimensional films are described herein, where various embodiments of the methods, apparatus, and products may include some or all of the elements, features and steps described below.

The use of a novel polymer, ethylene-vinyl acetate (EVA), in this context is explored herein as a supporting/carrier layer for transferring a two-dimensional film, such as graphene. The aforementioned challenging issues can be addressed by choosing a polymer support layer with advantageous properties for a particular application. Our study shows that EVA consisting of ethylene and vinylacetate units was such a polymer for many applications. EVA is lighter, more flexible, ease-stretchable, and less deformation than PMMA. In addition, other properties, such as a higher thermal conductivity with a higher CTE, lower glass transition temperature (T_{g}), lower elastic modulus, and high elongation capability, all contribute to making EVA an attractive option for the transfer supporting material. Furthermore, the better solubility of EVA than PMMA in solvents can result in less residue being left on the surface of the two-dimensional film.

The methods described herein differ from U.S. Pat. No. 8,535,553 B2, in particular, because the present methods use ethylene vinyl acetate (rather than PMMA) as the carrier layer. EVA offers the following advantages over PMMA. First, EVA is more pliable/conforming; consequently, the use of EVA renders feasible transfer of the graphene film to and from non-flat surfaces to which the EVA can conform, which is believed to be unique. Second, EVA can be removed with xylene, which leaves less residue on the two-dimensional film (in comparison with the use of acetone to remove PMMA), thereby providing the two-dimensional film with better carrier mobility due to a cleaner surface.

### BRIEF DESCRIPTION OF THE DRAWINGS

FIG. 1 is a schematic illustration of a bending test experiment carried out with an atomic-force-microscopy (AFM) cantilever 18 on a freely suspended sample of graphene 12 adhered to a polymer transfer/carrier layer 14 on a SiO₂/Si substrate 20.

FIG. 2 plots representative load-displacement curves of nanoindentation for suspended polymer and polymer/graphene films. The mechanical properties were characterized by a Digital Instrument Nanoscope IIIA from Veeco. A set of indentations were performed using calibrated silicon tips glued to Al-coated cantilevers with a spring constant of 80 N m⁻¹ and a resonance frequency of 320 KHz.

FIG. 3 plots the elastic modulus values (E) for PMMA/graphene (at left) and EVA/graphene films (at right) with indicated error bars of measurements.

FIGS. 4 and 5 include drawings and photographic images of different behaviors in a transfer process between PMMA/graphene (in FIG. 4) and EVA/graphene (in FIG. 5) during a transfer process. The back side of a coin (1 cent) was chosen for an arbitrary target substrate 20. The schematic illustrations in FIGS. 4 and 5 represent the sequential steps for transferring graphene 12 to an arbitrary target substrate 20.

FIGS. 6 and 7 illustrate a simulation analysis using Abaqus FEA software (from ABAQUS Inc.) to simulate a PMMA/graphene film 12/14′ (FIG. 6) and an EVA/graphene film 12/14″ (FIG. 7) attached to a contoured target substrate 20 surface using 20 pounds per square inch (psi) pressure. The part shown in the square is enlarged on the inset on the bottom. Insets show the normalized stress distributions of polymer/graphene films 12/14 under a pressure of 20 psi.

FIG. 8 provides schematic illustrations of steps for transferring CVD graphene film 12 with a PMMA 14′ or EVA 14″ carrier layer including polymer spin-coating, Cu etching, isotropic expanding, and transferring to a target substrate 20. Graphene ripples generated by textured copper can be diminished by isotropic expansion of the EVA carrier layer 14″ (by heating to 90° C.).

FIG. 9 illustrates the results of graphene transfer, showing a comparison between different support/carrier layers. The textured Cu foil with concentric circle patterns (used here as a growth substrate 16) was prepared by pressing the Cu foil 16 with a pre-patterned mold. All graphic images and height analyses were taken before stripping off supporting materials from the substrate. The scale bars in optical and topographical images are 1 mm.

FIGS. 10 and 11 schematically illustrate a comparison of thermal expansion effects between PMMA/graphene 14′/12 (FIG. 10) and EVA/graphene 14″/12 (FIG. 11) during the transfer process. The schematic illustrations presented here represent the sequential steps of graphene transfer from a rough Cu foil 16 onto a SiO₂/Si wafer 20. Structural defects on the transferred graphene 12 were observed after stripping away the PMMA 14′. The graphene surface after stripping off the PMMA 14′ also showed some polymer residue of the PMMA 14′.

FIG. 12 plots 532-nm excited Raman spectra of graphene transferred using PMMA 14′ and EVA 14″ as supporting carrier layers. The positions of I_{D}/I_{G} and I_{2D}/I_{G} of each sample are labeled together, respectively.

FIG. 13 is an OM image of a back-gated graphene field-effect transistor.

FIG. 14 plots the carrier mobility distribution of graphene samples transferred by the PMMA-supported method (bottom) and by the EVA-supported method (top).

FIG. 15 plots the relation between carrier concentration and carrier mobility. The points and circles are for devices fabricated by PMMA and EVA-supported transferred graphene films.

FIG. 16 plots drain current-back gate voltage (I_{D}-V_{G}) curves for graphene field-effect transistor (GFET) samples transferred by the PMMA-supported method (at right) and by the EVA-supported method (at left).

FIG. 17 plots the Dirac point voltage (V_{Dirac}) for 10 GFET samples transferred by the PMMA-supported method (from ˜0-20 V) or by the EVA-supported method (from ˜30-55 V). All electrical measurements were carried out under environments of ambient air at room temperature (RT).

FIG. 18 illustrates the results of an oxidation resistance test of a graphene covered Cu coin. The XPS core-level Cu2p spectrum of the graphene coated and uncoated sections of the coin after 30% H₂O₂ exposure are plotted in the chart (uncoated copper at top and graphene-coated copper at bottom). The inset is a photograph of the graphene coated (right) and uncoated (left) coin. After exposure to H₂O₂, a definite contrast arises between the graphene-coated and uncoated regions. The graphene-coated region (right) maintained its original appearance, whereas the uncoated region (left) showed a substantial darkening.

In the accompanying drawings, like reference characters refer to the same or similar parts throughout the different views; and apostrophes are used to differentiate multiple instances of the same or similar items or alternatives sharing the same reference numeral. The drawings are not necessarily to scale; instead, an emphasis is placed upon illustrating particular principles in the exemplifications discussed below.

### DETAILED DESCRIPTION

The foregoing and other features and advantages of various aspects of the invention(s) will be apparent from the following, more-particular description of various concepts and specific embodiments within the broader bounds of the invention(s). Various aspects of the subject matter introduced above and discussed in greater detail below may be implemented in any of numerous ways, as the subject matter is not limited to any particular manner of implementation. Examples of specific implementations and applications are provided primarily for illustrative purposes.

Unless otherwise herein defined, used or characterized, terms that are used herein (including technical and scientific terms) are to be interpreted as having a meaning that is consistent with their accepted meaning in the context of the relevant art and are not to be interpreted in an idealized or overly formal sense unless expressly so defined herein. For example, if a particular composition is referenced, the composition may be substantially (though not perfectly) pure, as practical and imperfect realities may apply; e.g., the potential presence of at least trace impurities (e.g., at less than 1 or 2%) can be understood as being within the scope of the description. Likewise, if a particular shape is referenced, the shape is intended to include imperfect variations from ideal shapes, e.g., due to manufacturing tolerances. Percentages or concentrations expressed herein can be in terms of weight or volume. Processes, procedures and phenomena described below can occur at ambient pressure (e.g., about 50-120 kPa—for example, about 90-110 kPa) and temperature (e.g., −20 to 50° C.—for example, about 10-35° C.) unless otherwise specified.

Although the terms, first, second, third, etc., may be used herein to describe various elements, these elements are not to be limited by these terms. These terms are simply used to distinguish one element from another. Thus, a first element, discussed below, could be termed a second element without departing from the teachings of the exemplary embodiments.

Spatially relative terms, such as “above,” “below,” “left,” “right,” “in front,” “behind,” and the like, may be used herein for ease of description to describe the relationship of one element to another element, as illustrated in the figures. It will be understood that the spatially relative terms, as well as the illustrated configurations, are intended to encompass different orientations of the apparatus in use or operation in addition to the orientations described herein and depicted in the figures. For example, if the apparatus in the figures is turned over, elements described as “below” or “beneath” other elements or features would then be oriented “above” the other elements or features. Thus, the exemplary term, “above,” may encompass both an orientation of above and below. The apparatus may be otherwise oriented (e.g., rotated 90 degrees or at other orientations) and the spatially relative descriptors used herein interpreted accordingly.

Further still, in this disclosure, when an element is referred to as being “on,” “connected to,” “coupled to,” “in contact with,” etc., another element, it may be directly on, connected to, coupled to, or in contact with the other element or intervening elements may be present unless otherwise specified.

The terminology used herein is for the purpose of describing particular embodiments and is not intended to be limiting of exemplary embodiments. As used herein, singular forms, such as “a” and “an,” are intended to include the plural forms as well, unless the context indicates otherwise. Additionally, the terms, “includes,” “including,” “comprises” and “comprising,” specify the presence of the stated elements or steps but do not preclude the presence or addition of one or more other elements or steps.

To demonstrate the generality and reliability of the graphene transfer method described herein, two extreme cases were considered to verify and validate the EVA-supported graphene transfer method. One case is “graphene transfer onto a rough substrate”, and the other case is “graphene transfer from rough copper (Cu)”. The EVA-supported transfer process is compatible with the established PMMA-supported transfer, and the desired device properties of graphene using EVA as a supporting/carrier material were shown to have better quality than those properties when using PMMA.

For graphene to be transferred onto flat substrates, much effort has previously been made to avoid cracks or broken regions in the graphene. It was commonly observed that if a certain region of graphene does not have continuous contact with the substrate, then that region very often will break after the PMMA carrier layer is removed. Therefore, in order to transfer graphene onto rough substrates with minimal broken regions, continuous conformal contact is advantageous. For this reason, we concluded that preservation of the advantageous mechanical properties of the polymer/graphene layer is advantageous for many applications.

Amorphous polymers (e.g., PMMA) are usually hard and brittle below their glass transition temperature because of the low mobility of their molecules, whereas the semi-crystalline polymers (e.g., EVA) with relatively strong intermolecular forces exhibit more rubber-like behavior, thereby providing elasticity and impact resistance. Our investigation started with an evaluation of the elastic properties of the polymer/graphene layer.

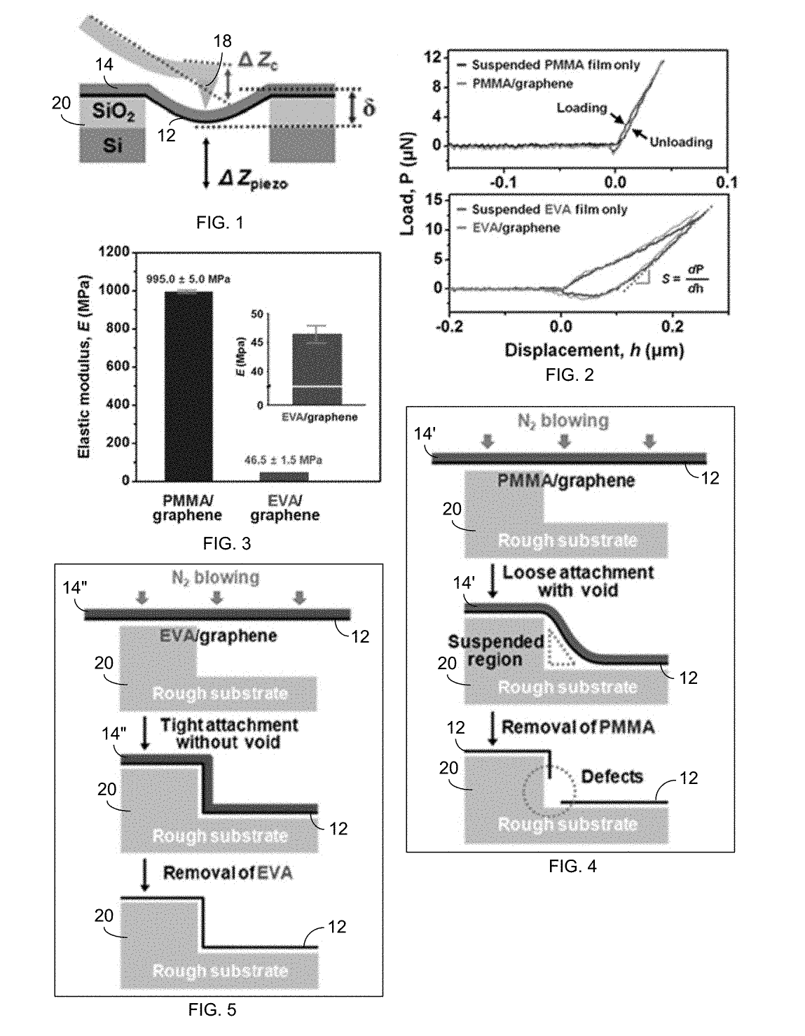

FIG. 1 shows a schematic diagram of a nano-indentation experiment with an atomic force microscope (AFM) tip 18 at the center of the suspended polymer (PMMA or EVA) or polymer/graphene layer 14/12. A freely suspended EVA film (bottom plot) revealed a substantial decrease in the elastic modulus (E) through load-displacement tests (as shown in the bottom plot of FIG. 2). The elastic modulus of the suspended polymer film was obtained from the initial unloading contact stiffness, S, which is defined as,

S=dP/dh, Eq. (1)

and is measured as the slope of the initial portion of the unloading curve. Based on Sneddon's theory, the initial unloading contact stiffness, S, can be derived as follows,

S=2β[(A/π)Eᵣ]^{0.5}, Eq. (2)

where A is the contact area, β is a constant related to the geometry of the indenter (for a Berkovich indenter, β=1.034), and Eᵣ is the reduced elastic modulus. The quantity Eᵣ can be calculated from the following equation,

1/Eᵣ=[(1−v²)/E]+[(1−vᵢ²)/Eᵢ], Eq. (3)

where E and v are the elastic modulus and Poisson's ratio of the polymer films, respectively, and Eᵢ and vᵢ are the same quantities for the nano-indenter (Eᵢ=179 GPa, vᵢ=0.278).

Assuming that the polymer/graphene film is a composite, we can predict the E values using the rule of mixtures. Under our experimental condition, the E values of the polymer/graphene films were estimated as 995.0±5.0 and 46.5±1.5 MPa for the PMMA/graphene and EVA/graphene films, respectively (as shown in FIG. 3). Generally, the overall properties of the composite are dependent on the volume fraction of the components. In this polymer/graphene composite system, since the graphene is only 1 atomic layer in thickness, the volume fraction of the graphene is extremely small (<0.00003). Even though graphene has an extremely high E value (1 TPa), the resulting E values of polymer/graphene film (as shown in FIG. 2) were almost the same as the those of polymer films alone, indicating that the mechanical property of the polymer conformal layer 14 is playing the dominant role in the polymer/graphene film. It should be noted that the approximately one-twentieth lower E value of the EVA/graphene film implies a tremendously lower stiffness in comparison with the PMMA/graphene film, and it is also anticipated that the EVA/graphene film 14″/12 would follow the surface of the underlying target substrate 20 much better and have a tighter attachment to the surface of the target substrate 20.

The influence of the mechanical properties of polymer support on the graphene transfer was investigated by using the back side of a one-cent U.S. coin (95% copper, 1962-1982 vintage) as an example of a rough target substrate 20. Indeed, PMMA/graphene and EVA/graphene films exhibited quite different behaviors when transferred to such a coin. As was seen via optical microscopy (OM), quite a lot of unattached/suspended regions were observed between the PMMA/graphene film 14′/12 and the features on the target substrate 20 (giving rise to a reflected greenish color), as shown in FIG. 4. Thus, the PMMA/graphene film 14′/12 indeed does not make a conformal contact following the features on the substrate; and the unattached/suspended regions of the film 12/14′ will break easily either during or after the PMMA carrier layer 14′ is being stripped away (as illustrated in the schematic explanation in FIG. 4). In contrast, as seen in an OM image and in the illustrated drawing of FIG. 5, the EVA/graphene film 14″/12 covered the surface of the side wall of the target substrate 20 and made tight contact with the target substrate 20 without any unattached/suspended region, as anticipated. Furthermore, two magnified OM images captured at different focal planes confirmed that the EVA/graphene film 14″/12 was completely attached to the target substrate 20.

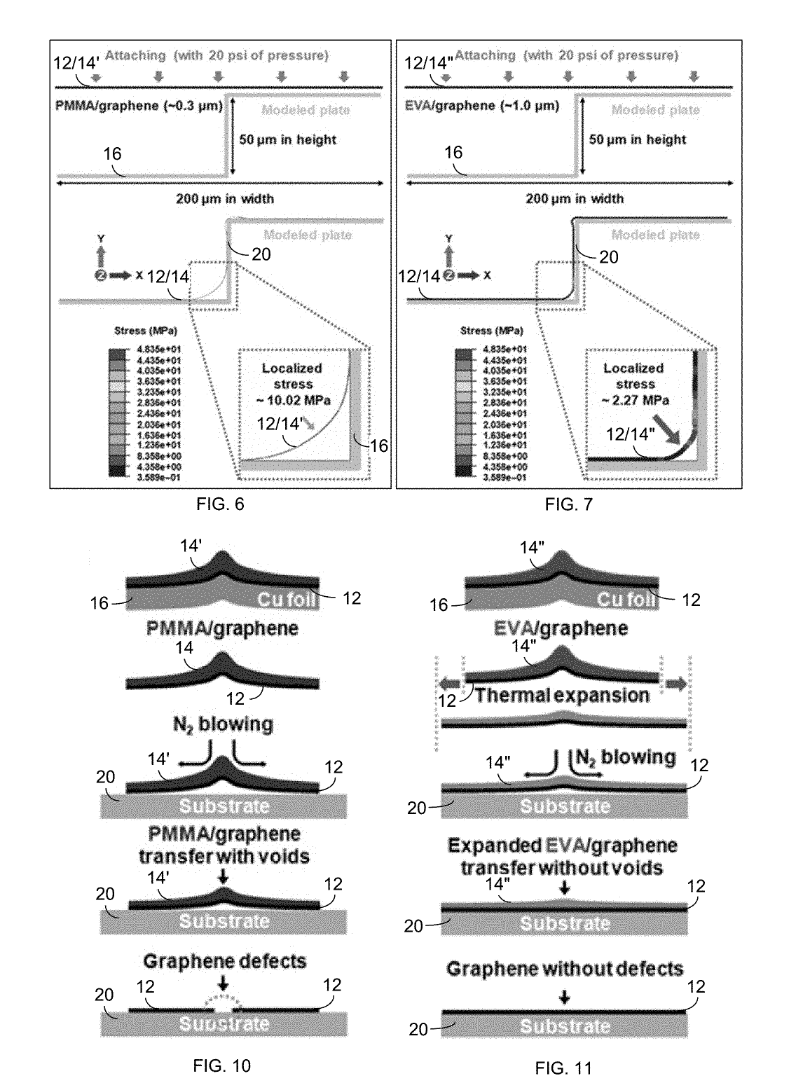

To compare the actual transfer results with the theoretical predictions, a simulation was constructed and performed based on a finite element analysis using the ABAQUS FEA software (from ABAQUS Inc.). FIGS. 6 and 7 show the ABAQUS setups that have been used in the present study, where both the PMMA/graphene 14′/12 (FIG. 6) and EVA/graphene 14″/12 (FIG. 7) are transferred to a step edge of a substrate 20 (modeled as a plate with a 200-μm width and a 50-μm depth). We used this plane strain case capability to mimic the scenario in the experiment, with the long distance along one direction of the slots in the coins. A very thin polymer/graphene film 14/12 is placed exactly above the modeled plate 20. The thicknesses of the polymer/graphene film 14/12 was set to be 0.3 and 1.0 μm for the PMMA and EVA, respectively (which correspond to the typical thicknesses of the two types of polymers when they are used for graphene transfer). The N₂ blowing pressure used in the simulation was set to be 20 psi.

Because the interaction between the polymer/graphene film 14/12 and the coin 20 is essentially not known, we assume a typical friction surface with a friction coefficient of 0.35. Even though PMMA is an elastic-plastic polymer, while EVA is a visco-elastic material, we have assumed (in order to simplify the setup) that these two materials have linear elastic and Young's modulus values set to be the values we obtained from our nano-indentation experiments. Even though the EVA is thicker, the EVA can be closely attached to the plate 20, while the PMMA cannot. Thus, the PMMA carrier layer 14′ left some suspended part behind, which will damage the graphene 12 during or after the polymer stripping process. It has also been known that fatigue crack (or fracture) growth is related to the residual stress level. Indeed, the stress distributions of the attached polymer/graphene films 14/12 showed that the localized stress value of the EVA/graphene film 14″/12 was 2.27 MPa at the bottom corner of plate 20, which is ¼ less than that of the PMMA/graphene film 14′/12 (10.02 MPa). This result is in close agreement with the results obtained from the nano-indentation test. The EVA/graphene film 14″/12 exhibited a relatively low E value, which resulted in significantly lower residual stresses as compared to the PMMA/graphene film 14′/12. Namely, the coordination between the higher elasticity and lower stiffness was found to play a pivotal role in the ability to transfer graphene successfully onto arbitrary substrates.

To further verify that the EVA-supported graphene transfer leads to a complete unitary graphene layer on the coin substrate, an anti-corrosion test was performed on the one-cent coin exposed to 30% H₂O₂ as an oxidizing agent. Absent a crack or broken region in the transferred graphene, the molecular diffusion barrier property of graphene's sp² honeycomb lattice was expected to prevent the Cu coin from leaching reactive chloride ions (Cl⁻). After exposure to H₂O₂, a definite contrast arises between the graphene-coated and uncoated regions. The graphene-coated region (right) maintained its original appearance, whereas the uncoated region (left) showed a substantial darkening (as shown in FIG. 17). In addition, the XPS survey spectrum reveals that the graphene-coated region in the inset of FIG. 17 exhibits two distinct Cu peaks at around 932.5 and 952.5 eV in the XPS spectrum (bottom trace), which correspond to the Cu2p_{3/2} and Cu2p_{1/2}, respectively. The uncoated region, however, displays broader Cu2p_{3/2} and Cu2p_{1/2} XPS peaks, which can be attributed to the presence of copper oxides; Cu₂O (932.5 and 952.3 eV), CuO (933.6 and 953.4 eV), and Cu(OH)₂ (934.7 and 954.5 eV). Furthermore, the several satellite peaks that are seen in the Cu 2p spectra (top trace in FIG. 17) provides definitive evidence for the presence of Cu²⁺ ions on the bare Cu coin surface. These XPS data indicated that the EVA-transferred graphene indeed served as a diffusion barrier to protect the underlying Cu coin from oxidation. Such a test is a quick way to verify that the EVA-transferred graphene is free from structural tears and broken regions over a large area.

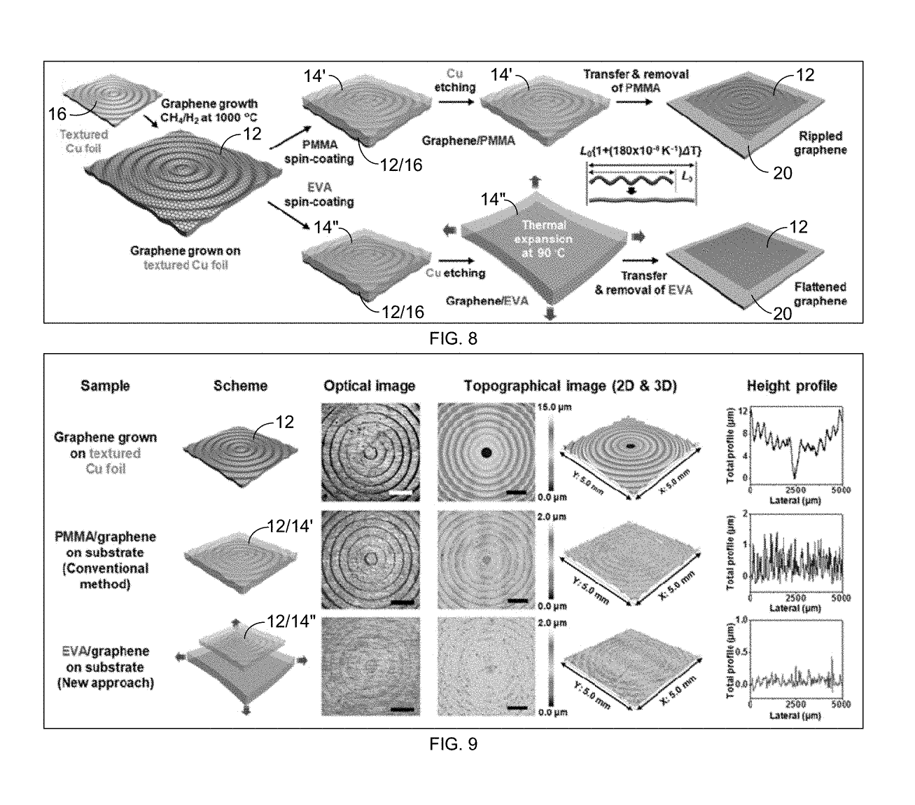

The as-grown graphene on a flat Cu foil usually shows many wrinkles due to the differences between the CTE of graphene and that of metallic Cu. For a Cu substrate with additional features, the conformal graphene growth on that Cu substrate will result in even more corrugations in the graphene film. In order to obtain a transferred graphene with both minimal broken regions and minimal wrinkles, we employed a novel hot-water bath transfer process in addition to using EVA as the polymer support. The overall procedures for transferring CVD grown graphene from textured Cu are illustrated in FIG. 8. Textures were obtained on a Cu foil simply by pressing the foil with a Fresnel lens as a mold. Afterwards, resulting conformal graphene was grown on these textured 25-μm-thick Cu foils (99.8%, Alfa Aesar) with concentric circle patterns via a typical low-pressure chemical vapor deposition (LPCVD) process.

After the growth process, graphene is transferred onto the final target substrate through either the conventional polymer-assisted wet transfer approach or the new hot-water bath approach. The old approach comprises the following three steps: (1) the spin-coating of polymer support/carrier materials, (2) wet chemical etching of the Cu foil, and (3) transferring the graphene/polymer onto the target substrate and removal of the polymer. The “old” and “new” transfer procedure differ in the third step. In a typical PMMA-mediated graphene transfer, a PMMA/graphene stack floats on the surface of a de-ionized (DI) water bath at room temperature, and the stack would be scooped out later and finally transferred onto a target substrate. In contrast, for the new approach, an EVA/graphene stack is floated on the surface of a hot DI water bath maintained at 90° C. for 1 h before scooping out (the remaining procedures are the same as those previously used for the PMMA-supported method). During this period of exposure to the DI hot water bath, two things can happen: (1) since 90° C. is close to the melting temperature (Tₘ) of EVA, EVA might become liquid-like and may smooth out on the graphene surface (Table 1, below); (2) the EVA layer may become isotropically expanded with the additional thermal energy. As a result, it can be anticipated that the wrinkles/corrugations in the graphene may be smoothed and stretched out. This smoothing and stretching allows the EVA/graphene stack to become tightly attached to the final substrate, thereby reducing the amount of wrinkles coming from the textured Cu foil. Consequently, it was expected that the graphene ripples that originated from the textured Cu surface can be lessened or eliminated during the transfer process through the flow and the isotropic expansion of EVA, whereas these ripples would have remained using the conventional PMMA-supported transfer.

TABLE 1
(comparison of property parameters between PMMA and EVA films):

| | Mechanical | | | | | | | |
|---|---|---|---|---|---|---|---|---|
| | properties | | Physical and chemical properties | | | | | |
| | Contact | Elastic | | | Thermal | CTE | | Solubility |
| | stiffness | modulus | | | conductivity | value | Molecular | parameter |
| Sample | (μN μm⁻¹) | (GPa) | T_{g} (° C.) | Tₘ(° C.) | (W m⁻¹K⁻¹) | (×10⁻⁶K⁻¹) | formula | (MPa^{1/2}) |
| PMMA | 272.64 | 1.00 | 105 | 160 | 0.21 | 70 | (C₅O₂H₈n) | 18/19.7 |
| EVA | 94.06 | 0.05 | 61 | 87 | 0.34 | 180 | (C_{c}H₄)n | 18.05/18.2 |
| | | | | | | | (C₄H₆O₂)m | |

In the above table, the solubility parameters represent PMMA/acetone and EVA/xylene for the PMMA and EVA solutions, respectively.

Characterizations of graphene transferred by the two different techniques were carried out; and the results were compared by an OM, α-step profilometer, as shown in FIG. 9. The OM image of the textured Cu exhibited well-defined concentric circle patterns, which replicate the features on the original lens. The height analysis in FIG. 9 revealed that the wavelength and amplitude of the features on Cu before and after the growth were both about 300 μm and 1.5 μm, respectively. With the conventional PMMA transfer method, these ripple (wavy) patterns were replicated and transferred to the final target substrate. The OM and topographical images show that identical patterns of the textured Cu still remained on the PMMA/graphene stack. The EVA/graphene transferred onto flat SiO₂/Si substrates, on the other hand, had much diminished patterns (as seen in FIG. 9), as revealed by the lower color contrast in the OM and much reduced variation in the topographic height profile. The difference in height between the high and low patterns ranged from 0.1 to 0.2 μm in the EVA/graphene stack, which in comparison is much smoother than that of PMMA/graphene stack (ranging from 0.5 to 1.3 μm). Consequently, it was found that the macroscopic wrinkles from textured Cu could be reduced (or even removed) by introducing the EVA polymer as a support/carrier material. Further details of the mechanism and structural formation during transfer are discussed below.

As mentioned earlier, our new graphene transfer with EVA exploits its thermal properties. In general, most solid materials expand upon heating and contract when cooled. The fractional change in length (l) with temperature (T) may be expressed as,

(l_{f}−l₀)/l₀=α₁(T_{f}−T₀) or Δl/l₀=α₁ΔT, Eq. (4)

where l₀ and l_{f} are the initial and final lengths as the temperature is changed from T₀ to T_{f}; respectively. The parameter α₁ is the linear CTE. This CTE value is a material property that is indicative of the ability of the material to increase its length as the result of an applied thermal energy. The thermal conductivity (x) is also an important factor in heat transfer. Under our experimental conditions, the α₁ and x values were estimated using Eq. (4) and Fourier's law, and the results are summarized in Table 1, above. It is known that a single graphene layer has negative CTE value. At room temperature (300 K), graphene exhibits an α₁ value of ca. −7×10⁻⁶ K⁻¹, and α₁ decreases with increasing temperature.

In this study, the variation of the graphene's CTE value in the temperature range of interest was found to be negligible. It is worth noting that the α₁ value for EVA is approximately 2.6 times higher than that of PMMA. Therefore, while the PMMA was dilated to l₀{1+(70×10⁻⁶ K⁻¹)ΔT} at a given temperature, the EVA expanded to l₀{1+(180×10⁻⁶ K⁻¹)ΔT} at a given temperature, which is more than twice the expansion of PMMA. We also expected that the high thermal conductivity (0.34 Wm⁻¹K⁻¹) and the relatively high CTE value (180×10⁻⁶ K⁻¹) of EVA would have a combined or synergistic effect on the isotropic expansion of EVA during the transfer process.

The schematic diagrams in FIGS. 10 and 11 depict the likely scenarios for the old and new transfer approaches. With the conventional PMMA-supported graphene transfer, the wrinkled or folded graphene regions due to the features on the Cu growth substrate would not make tight contact with the target substrate, as evidenced in FIG. 10. This absence of uniform flush contact gives rise to voided regions in the graphene; accordingly, broken regions were observed after the PMMA stripping. On the other hand, the EVA/graphene film expanded in response to the increased temperature, and the wavy patterned EVA/graphene film can be flattened and transferred with much better contact to the final substrate (as seen in FIG. 11). Indeed, in this case, a clean and continuous transferred graphene surface without broken regions was observed for the EVA/graphene film.

The isotropic expansion, of course, can be applied to the conventional PMMA-supported transfer. The applied thermal energy also has an influence on the PMMA/graphene film, but their length change by thermal expansion is insignificant.

This effect is further demonstrated in an extreme scenario, where the two approaches were compared when a crumpled Cu foil is used as a growth substrate for graphene. Photographs and OM images revealed excellent continuity over a millimeter-sized length scale, without observable cracks or tears in the graphene transferred by EVA using the new hot-water bath approach, while the conventional transfer approach using PMMA resulted in a severely broken graphene film.

The residues of the support/carrier material, especially polymer residues of PMMA, inevitably remained on the graphene surface and adversely affected the graphene's intrinsic electrical properties. Apart from the advantageous mechanical properties of EVA, its physical/chemical properties also result in less residue on the graphene, which can be advantageous for device applications. The chemical parameters of a polymer in a solvent, including the intermolecular interaction, chain conformation, and solubility, are strongly affected by the inherent properties of the polymer as well as by the environmental conditions where the polymer is used. In particular, the solubility parameter (δ) can be considered as an important factor in determining the dissolution efficiency of the support/carrier material.

The Hildebrand-Scatchard equation is an equation for calculating the enthalpy change (ΔHₘ) for the polymer-solvent mixing system, and can be expressed as,

ΔHₘ=Vₘ(δₚ−δₛ)²φₚφₛ, Eq. (5)

where Vₘ is the volume of the mixture, δₚ and δₛ are the solubility parameters, and φₚ and φₛ are the volume fraction of the polymer and solvent, respectively. For a polymer to be soluble in a solvent, the change in the Gibbs free energy of mixing (ΔGₘ) must be negative (favorable) in accordance with the following basic thermodynamic equation,

ΔGₘ=ΔHₘ−TΔSₘ, Eq. (6)

where T is the temperature, and ΔSₘ is the entropy of mixture. The ΔSₘ term is usually positive, and thus, ΔHₘ is the determining factor. Since ΔHₘ≈(δₚ−δₛ)², the highest solubility is achieved when the δₚ and δₛ values are equal, due to a negative entropy term. Namely, mixtures of materials with similar δ values are likely to be miscible and thermodynamically compatible.

Acetone is the most widely used solvent for dissolving/removing PMMA. From Table 1, PMMA has a solubility parameter of about 18 MPa^{1/2}, and the solubility parameter difference (|δ_{PMMA}−δ_{Acetone}|) is 1.7. In the case of EVA (δₚ value of 18.05 MPa^{1/2}), however, acetone is not a suitable solvent for EVA due to the solubility parameter mismatch. An aromatic hydrocarbon, such as xylene, is a more suitable solvent for dissolving/removing EVA. For this study, xylene with a δₛ value of 18.2 MPa^{1/2} was chosen to promote a more effective removal of EVA residues from the graphene surface. The |δ_{EVA}−δ_{Xylene}| value is revealed to be 0.15, indicating that xylene is the “better solvent” for EVA (Table 1). Thus, it is anticipated that the interactions between the EVA polymer and the xylene solvent should be energetically favorable to allow the solvent swell of the EVA polymer chains to dissolve away from the graphene surface more effectively.

Although the EVA residue can be greatly reduced due to the energetically favorable reaction, some EVA residues on graphene surface may still exist. OM and AFM images suggest that the EVA-transferred graphene has much less wrinkling and a much more uniform morphology with less contamination than the graphene films transferred by PMMA.

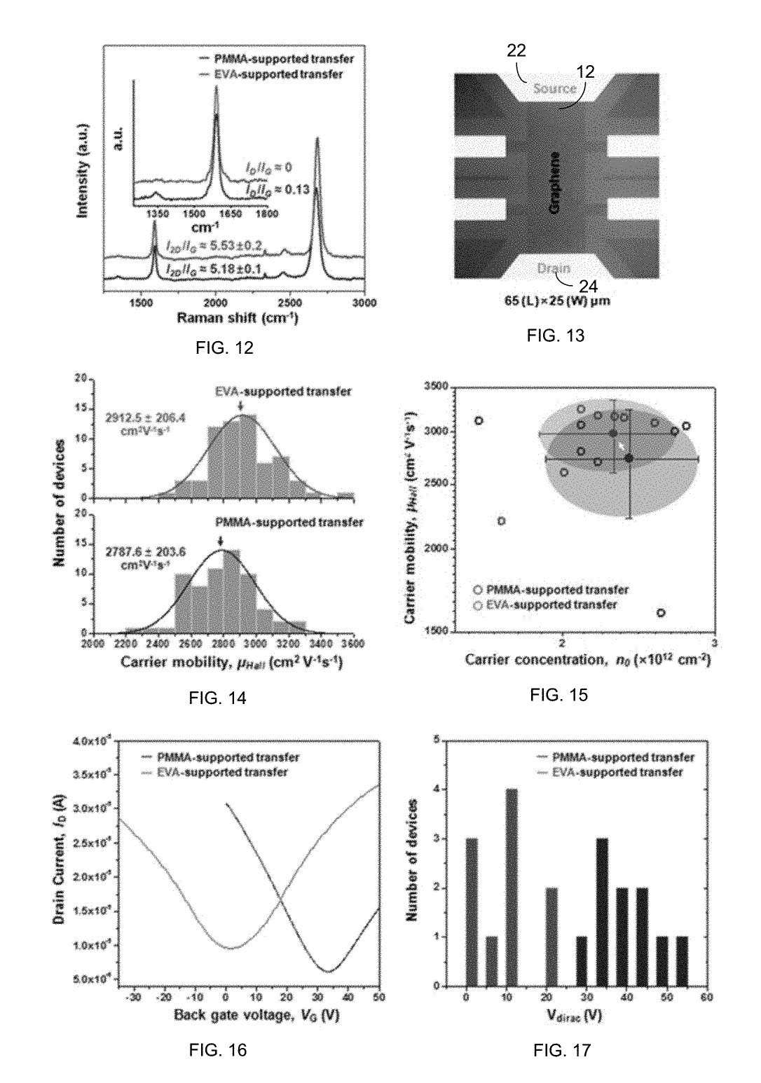

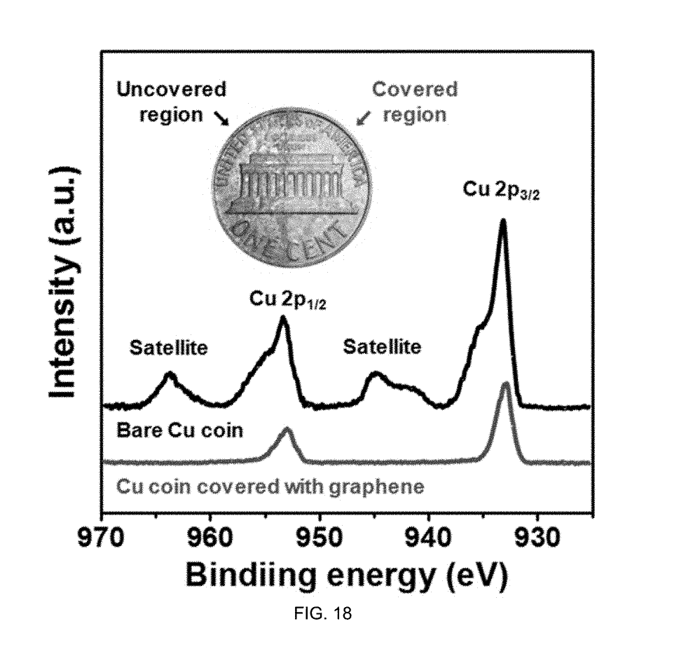

To compare the quality of the transferred graphene films (using PMMA and EVA), Raman spectroscopy characterization (532 nm laser wavelength) was first performed before electrical characterization, as shown in FIG. 12. It is clear that both graphene samples have a typical monolayer graphene Raman spectrum with the G- and 2D-bands at 1590 and 2675 cm⁻¹, exhibiting a ratio of integrated peak intensities (I_{2D}/I_{G}) of larger than 5.0. There is no significant difference in the ω_{G} and I_{2D}/I_{G} values between the two samples. Nonetheless, the integrated intensity ratio between D and G peak (I_{D}/I_{G}) of the EVA-transferred graphene was negligible below the Raman detection limit, while that of the PMMA-transferred graphene was around 0.13, presumably due to the presence of the PMMA residues (FIG. 12 inset). This characterization suggested that the EVA-supported transfer method is relatively beneficial to minimize the creation of defects in the graphene during the transfer process.

Taking full advantage of the hot-water bath, EVA-supported transfer method, the electrical properties of two different types of graphenes 12 were investigated using a back-gated graphene field-effect transistor (GFET) device. FIG. 13 is a top-view OM image of the back-gated graphene FET with a channel length (L) of 65 μm and width (W) of 25 μm. An underlying p-type SiO₂/Si wafer serves as a back gate for the GFET, and the Ti/Au source 22 and drain 24 pads were formed by photolithography. All of the measurements were carried out in ambient air at room temperature (RT). Compared with the GFET based on graphene 12 transferred by PMMA 14′, the graphene 12 transferred by EVA 14″ exhibits lower sheet resistances with a narrower distribution. The graphene samples 12 transferred with the EVA 14″ carrier layer method exhibit an average sheet resistance (Rₛ) of 366.8±82.9 Ωsq⁻¹, lower than that of PMMA 14′ (460.5±132.1 Ωsq⁻¹).

The carrier mobility can be extracted from the sheet resistance by using the simple Drude model. Since poly-crystalline graphene samples grown by the Cu-mediated LPCVD process were used for the fabrication, the carrier mobility values themselves were not as high as those of the exfoliated graphene samples from natural graphite and HOPG. Nonetheless, compared with the GFET based on graphene transferred by PMMA, the graphene transferred by EVA exhibits a slightly higher carrier mobility (μ_{Hall}). FIG. 14 depicts the distribution of the μ_{Hall} of GFET devices (total ˜60 devices). A Gaussian fit indicates the carrier mobility values of 2912.5±206.4 and 2787.6±203.6 cm² V⁻¹ s⁻¹ for graphenes transferred by EVA and PMMA, respectively. Besides the sheet resistance and carrier mobility, carrier concentration (n₀) is also a parameter of concern in GFET devices, since n₀ reflects the degree of charge impurity scattering. It can be seen that the EVA-supported transfer method gave rise to a decreased carrier concentration and an increased carrier mobility, as shown in FIG. 15. Under our experimental condition, the n₀ values in FIG. 15 were found to be 2.3×10¹²±0.5 and 3.8×10¹²±1.5 cm⁻² for graphenes transferred by EVA and PMMA, respectively.

FIG. 16 shows representative current-voltage (I_{D}−V_{G}, where I_{D} is the drain current, and V_{G} is the gate voltage) curves for the GFETs. The I_{D}−V_{G} curve of the GFET transferred by the PMMA-supported transfer method displays a further shifted Dirac point voltage (V_{Dirac}) than the EVA-transferred graphene. FIG. 17 summarizes the results for the devices tested. The average V_{Dirac} values were 11.5±8.0 V and 38.6±7.1 V for the GFETs transferred by EVA and PMMA, respectively. Generally, the V_{Dirac} value depends on the following factors: the charge transfer doping from the H₂O/O₂ molecules, the metal contact effects, and an increase in the external scattering sites due to polymer residue. Under our experimental conditions, all devices were prepared at the same time to avoid interference from additional doping effects. Thus, we speculate that the tendency to the positive shift of V_{Dirac} may be due to the existence of PMMA residue (but with a substantially reduced polymer residue on the EVA graphene), since everything else was essentially the same for the fabrication of both devices. Physisorbed molecules on the graphene surfaces impact the electrical properties and alter the electronic structure of graphene. A thin PMMA layer left on the graphene is reported to cause a p-type doping behavior in GFETs. Furthermore, the fact that EVA graphene samples have a considerably lower wrinkle density could be attributed to the higher mobility and the decreased Rain those samples.

In conclusion, as an alternative supporting material for graphene transfer, EVA was explored to tackle the challenging issues now found in the established PMMA-supported transfer process. It was found that EVA's excellent materials properties not only enable a conformal transfer onto uneven substrates without damaging the graphene continuity, but also result in much less residue on the graphene after transfer. With a novel hot-water bath expansion approach, the density of the wrinkles or folds in the graphene is much reduced, which also enables a more successful transfer of graphene from a rough Cu substrate. Although this work only investigated the transfer of graphene from one substrate to another, it is anticipated that the use of EVA as a support/carrier material can also be used to effectively transfer other 2D materials (i.e., other mono- or few-atomic-layer films, such as h-BN, MoS₂, MoSe₂, WS₂, WSe₂), as well.

### Experimental Section:

Graphene Synthesis:

High-quality monolayer graphene was grown on 25-μm thick Cu foils (99.8%, from Alfa Aesar) using a LPCVD method that we demonstrated previously in Y. C. Shin, J. Kong, “Hydrogen-Excluded Graphene Synthesis via Atmospheric Pressure Chemical Vapor Deposition”, 59 Carbon 439 (2013). Before the CVD growth, the Cu foils were treated with the commercial Ni etchant (Nickel Etchant TFB, Transense) to allow reproducible synthesis of clean and continuous monolayer graphene. After the pre-cleaning process, the various types of Cu foils (flat, textured, crumpled) were loaded into a CVD chamber. Under low pressure (1.5 Torr), the textured Cu foil was annealed in a gas flow of 50 standard cubic centimeters (sccm) of hydrogen (H₂) at 1000° C. for 60 min. After the annealing step, 6 sccm of methane (CH₄) gas was introduced to initiate the graphene growth, for 40 minutes. The graphene growth was carried out at 1000° C. To control the graphene growth rate, 20 sccm of H₂ flow was used during the growth period. Once the graphene growth was finished, the CVD chamber was cooled down under 20 sccm of H₂ to prevent oxidation and to minimize hydrogenation reactions of the graphene.

PMMA-Supported Graphene Transfer:

After graphene growth, a PMMA solution (PMMA, 950 A9, MicroChem, diluted to 4.5 wt. % in anisole) was spin coated onto the top side of the sample at 2500 rpm for 60 seconds and dried for 15 minutes in an oven held at 80° C. Before the Cu etching process, the back-side graphene was removed by oxygen plasma etching for 3 minutes at a plasma power of 100 W. Copper etchant (CE-100, Transene Company Inc.) was used to etch Cu foil, and the PMMA/graphene film was floated on the surface of the solution. The PMMA/graphene film was moved to distilled water several times to rinse the etchant residue. After rinsing the PMMA/graphene film with distilled water, the PMMA/graphene film was placed on a target substrate (300 nm SiO₂/Si wafer) by being scooped out at room temperature and then dried by compressed N₂. After blowing the compressed N₂, the sample is dried in an oven at 80° C. for several hours to enable the complete evaporation of moisture from the sample. Acetone is used to selectively remove the PMMA from the PMMA/graphene/SiO₂/Si wafer. The PMMA was removed by soaking the sample in an acetone bath overnight and then drying in air.

EVA-Supported Graphene Transfer:

After graphene growth, an EVA solution (Aldrich, vinyl acetate 18 weight-%, 10 weight-% dissolved in xylene) was spin coated onto the top side of the sample at 4000 rpm for 60 seconds and dried in an oven at 80° C. for 60 minutes. For the EVA-supported graphene transfer, the overall processes were the same as the above procedure except for the final step (transferring EVA/graphene onto the target substrate and removal of EVA). To produce a thermal expansion of EVA layer, the EVA/graphene film, in a distilled water bath, was kept at 90° C. for 1 hour before scooping out the film. Subsequently, the EVA/graphene/300-nm SiO₂/Si wafer was dried in an oven at 80° C. for several hours to enable the complete evaporation of moisture from the sample. Xylene was used to selectively remove the EVA. Specifically, the EVA was dissolved and washed out by soaking the film in a boiling xylene bath for 15 min, and the film was then dried in air.

Device Preparation and Electrical Performance Measurements:

For the back-gated GFET devices, the metallization with a Ti/Au layer was implemented on the graphene by evaporation and a subsequent lift-off process after the patterning was accomplished by using an Elionix ELS-F125 electron beam lithography system. O₂/He plasma was used to pattern the graphene channels. 60 back-gated GFET devices were thus fabricated where the channel length and width were 65 and 25 μm, respectively. All the electrical performance data in the main text were measured with an Agilent 4155 Parameter Analyzer in ambient air at room temperature.

Characterizations:

The morphology was confirmed using optical microscopy (using a Zeiss Primo Star Microscope from Carl Zeiss). The surface profile was taken by using a P-16 Surface Profilometer (from KLA-Tencor). The Raman measurement was carried out using a Horiba-Jobin Yvon raman spectroscopy system with a 532-nm Ar+ laser line. The laser power used was around 1 mW on the sample, and a 100× objective was used to focus the beam. The diameter of the laser beam on the sample was around 1 μm. The mechanical properties of the films were characterized by a Digital Instrument Nanoscope IIIA from Veeco. A set of indentations was performed using calibrated silicon tips glued to Al-coated cantilevers with a spring constant of 80 N/m and a resonance frequency of 320 KHz.

In describing embodiments of the invention, specific terminology is used for the sake of clarity. For the purpose of description, specific terms are intended to at least include technical and functional equivalents that operate in a similar manner to accomplish a similar result. Additionally, in some instances where a particular embodiment of the invention includes a plurality of system elements or method steps, those elements or steps may be replaced with a single element or step. Likewise, a single element or step may be replaced with a plurality of elements or steps that serve the same purpose. Further, where parameters for various properties or other values are specified herein for embodiments of the invention, those parameters or values can be adjusted up or down by 1/100^{th}, 1/50^{th}, 1/20^{th}, 1/10^{th}, ⅕^{th}, ⅓^{rd}, ½, ⅔^{rd}, ¾^{th}, ⅘^{th}, 9/10^{th}, 19/20^{th}, 49/50^{th}, 99/100^{th}, etc. (or up by a factor of 1, 2, 3, 4, 5, 6, 8, 10, 20, 50, 100, etc.), or by rounded-off approximations thereof, unless otherwise specified. Moreover, while this invention has been shown and described with references to particular embodiments thereof, those skilled in the art will understand that various substitutions and alterations in form and details may be made therein without departing from the scope of the invention. Further still, other aspects, functions, and advantages are also within the scope of the invention; and all embodiments of the invention need not necessarily achieve all of the advantages or possess all of the characteristics described above. Additionally, steps, elements and features discussed herein in connection with one embodiment can likewise be used in conjunction with other embodiments. The contents of references, including reference texts, journal articles, patents, patent applications, etc., cited throughout the text are hereby incorporated by reference in their entirety; and appropriate components, steps, and characterizations from these references may or may not be included in embodiments of this invention. Still further, the components and steps identified in the Background section are integral to this disclosure and can be used in conjunction with or substituted for components and steps described elsewhere in the disclosure within the scope of the invention. In method claims (or where methods are elsewhere recited), where stages are recited in a particular order—with or without sequenced prefacing characters added for ease of reference—the stages are not to be interpreted as being temporally limited to the order in which they are recited unless otherwise specified or implied by the terms and phrasing.

What is claimed is:

1. A method for graphene transfer, comprising:
forming a two-dimensional film on a surface of a growth substrate, wherein a majority of the two-dimensional film has a thickness of no more than 10 atomic layers and substantially greater dimensions orthogonal to its thickness, wherein the two-dimensional film has first and second surfaces that face in opposite directions, and wherein the first surface of the two-dimensional film adheres to the growth substrate;
coating the second surface of the two-dimensional film, while adhered to the growth substrate, with a conforming carrier layer comprising ethylene vinyl acetate;
etching the surface of the growth substrate to release the two-dimensional film with the conforming carrier layer coating from the growth substrate, the conforming carrier layer maintaining the integrity of the two-dimensional film during and after its release from the growth substrate;
after the two-dimensional film is released from the growth substrate, applying the first surface of the two-dimensional film with the conforming carrier layer coating onto a target substrate to form a two-dimensional coating on the target substrate; and
removing the conforming carrier layer from the two-dimensional film by exposing the conforming carrier layer to a solvent while the two-dimensional film is coating the target substrate.

2. The method of claim 1, wherein the conforming carrier layer consists essentially of ethylene vinyl acetate with first and second surfaces, wherein the first and second surfaces of the conforming carrier layer face in opposite directions, and wherein the first surface of the conforming carrier layer is adhered to the two-dimensional film while the second surface of the conforming carrier layer is exposed.

3. The method of claim 1, wherein the solvent to which the conforming carrier layer is exposed comprises xylene.

4. The method f claim 1, further comprising thermally expanding the conforming carrier layer after the conforming carrier layer is coated on the two-dimensional film to reduce wrinkling of the two-dimensional film.

5. The method of claim 4, further comprising using a liquid to float the two-dimensional-film-coated conforming carrier layer between release of the two-dimensional film and protective support layer from the growth substrate and application of the two-dimensional film and protective support layer to the target substrate, wherein the liquid is heated to provide the thermal expansion of the conforming carrier layer.

6. The method of claim 1, wherein the growth substrate has non-flat surface features that are coated by the two-dimensional film and that protrude at least 10 nm outwardly from neighboring surface areas of the non-flat surface areas of the growth substrate to produce contours in the two-dimensional film and conforming carrier layers adhered to the non-flat surface features of the growth substrate.

7. The method of claim 1, wherein the target substrate has a non-flat surface to which the two-dimensional film is applied, wherein the non-flat surface has surface features that protrude outwardly at least 10 nm from neighboring surface areas of the non-flat surface of the target substrate.

8. The method of claim 1, wherein the ethylene vinyl acetate is spin-coated on the two-dimensional film.

9. The method of claim 1, wherein each of the first and second surfaces of the graphene film has an area of at least 1 cm².

10. The method of claim 1, wherein the two-dimensional film comprises a composition selected from graphene, h-BN, MoS₂, MoSe₂, WS₂, and WSe₂.

11. The method of claim 1, wherein the composition is graphene.
